(19) United States
(12) Patent Application Publication
(10) Pub. No.: US 2025/0362470 A1
(43) Pub. Date: Nov. 27, 2025

(54) OPTICAL ELEMENT AND METHOD FOR MANUFACTURING OPTICAL ELEMENT

(71) Applicant: AGC Inc., Tokyo (JP)

(72) Inventors: Atsushi TSUNODA, Fukushima (JP); Atsushi MATSUO, Tokyo (JP); Yoshihiro FUKUKAWA, Fukushima (JP)

(73) Assignee: AGC Inc., Tokyo (JP)

(21) Appl. No.: 19/293,044

(22) Filed: Aug. 7, 2025

Related U.S. Application Data
(63) Continuation of application No. PCT/JP2024/004617, filed on Feb. 9, 2024.

(30) Foreign Application Priority Data
Feb. 15, 2023 (JP) 2023-021436
May 29, 2023 (JP) 2023-087578

(51) Int. Cl. G02B 7/00

(52) U.S. Cl. CPC G02B 7/008

(57) ABSTRACT

An optical element includes a transmission region that transmits a part of light and a light-shielding region that shields another part of the light when viewed from a transmission direction of the light. The optical element includes a transparent glass body and a light-shielding film made of glass that forms the light-shielding region inside the transparent glass body.

### CROSS-REFERENCE TO RELATED APPLICATION(S)

This application is a continuation of International Application No. PCT/JP2024/004617, filed on Feb. 9, 2024 which claims the benefit of priority of the prior Japanese Patent Application No. 2023-021436, filed on Feb. 15, 2023 and Japanese Patent Application No. 2023-087578, filed on May 29, 2023, the entire contents of which are incorporated herein by reference.

### BACKGROUND OF THE INVENTION

### 1. Field of the Invention

The present disclosure relates to an optical element and a method for manufacturing the optical element.

### 2. Description of the Related Art

An optical unit described in WO 2021/176704 A includes a transparent first substrate, a transparent second substrate, and an aperture made of black resin filling a periphery of a projection between the first substrate and the second substrate. The first substrate and the second substrate are transparent glass substrates or transparent resin substrates.

In WO 2021/176704 A, a transparent resin substrate and a black resin constitute an optical element, or a transparent glass substrate and the black resin constitute an optical element. When the substrate is a resin substrate, a change in optical characteristics due to a temperature change becomes large. Therefore, the substrate is preferably a glass substrate. However, in a case where the glass substrate and the black resin constitute the optical element, the absolute value of the average linear expansion coefficient difference between the glass and the resin is large, and durability of the optical element against temperature change is low.

One aspect of the present disclosure provides a technique for improving durability of an optical element against a temperature change.

### SUMMARY OF THE INVENTION

It is an object of the present invention to at least partially solve the problems in the conventional technology.

The optical element of one aspect of the present disclosure includes a transmission region that transmits a part of light and a light-shielding region that shields another part of the light when viewed from a transmission direction of the light. The optical element comprises a transparent glass body, and a light-shielding film made of glass that forms the light-shielding region inside the transparent glass body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a plan view of an optical element according to an embodiment, and FIG. 1B is a cross-sectional view of the optical element according to the embodiment;

FIG. 2A is a diagram illustrating an example of a relationship between stress generated at a boundary line between a transmission region and a light-shielding region and a difference in average linear expansion coefficients, and FIG. 2B is a diagram illustrating another example;

FIG. 3 is a flowchart indicating a method for manufacturing the optical element according to the embodiment;

FIG. 4A is a cross-sectional view illustrating an example of S101, FIG. 4B is a cross-sectional view illustrating an example of S102, FIG. 4C is a cross-sectional view illustrating an example of S103, FIG. 4D is a cross-sectional view illustrating an example of S104, FIG. 4E is a cross-sectional view illustrating an example of S105, and FIG. 4F is a cross-sectional view illustrating an example of S106;

FIG. 5A is a plan view illustrating a first modification of the shape of the light-shielding region, FIG. 5B is a plan view illustrating a second modification of the shape of the light-shielding region, FIG. 5C is a plan view illustrating a third modification of the shape of the light-shielding region, and FIG. 5D is a plan view illustrating a fourth modification of the shape of the light-shielding region;

FIG. 6A is a cross-sectional view illustrating a first modification of the cross-sectional shape of a light-shielding film, FIG. 6B is a cross-sectional view illustrating a second modification of the cross-sectional shape of the light-shielding film, FIG. 6C is a cross-sectional view illustrating a third modification of the cross-sectional shape of the light-shielding film, FIG. 6D is a cross-sectional view illustrating a fourth modification of the cross-sectional shape of the light-shielding film, FIG. 6E is a cross-sectional view illustrating a fifth modification of the cross-sectional shape of the light-shielding film, and FIG. 6F is a cross-sectional view illustrating a sixth modification of the cross-sectional shape of the light-shielding film;

FIG. 7A is a cross-sectional view illustrating an example of the optical element including a plurality of light-shielding films at intervals in a transmission direction of light, and FIG. 7B is a view illustrating an example of the optical element in which the light-shielding film is embedded in a groove on a surface of a transparent glass body;

FIG. 8 is a diagram illustrating an example of a relationship between the cross-sectional shape of the light-shielding film and an internal transmittance of the light in the light-shielding film;

FIG. 9A is a diagram illustrating a first example of an intensity distribution of light on a projection surface of light, and FIG. 9B is a diagram illustrating a second example of the intensity distribution of light on the projection surface of light;

FIG. 10 is a diagram illustrating an example of a relationship among ΔI, W, and R_{T};

FIG. 11 is a diagram illustrating an example of a relationship among R_{V}, W, and R_{T};

FIG. 12 is a diagram illustrating an example of a relationship between ΔI and WA;

FIG. 13 is a flowchart indicating a modification of the method for manufacturing the optical element; and

FIG. 14A is a cross-sectional view illustrating an example of S201, FIG. 14B is a cross-sectional view illustrating an example of S202, FIG. 14C is a cross-sectional view illustrating an example of S203, and FIG. 14D is a cross-sectional view illustrating an example of S204.

### DETAILED DESCRIPTION OF THE PREFERRED EMBODIMENTS

Hereinafter, modes for carrying out the present disclosure will be described with reference to the drawings. In the drawings, the same or corresponding components are denoted by the same reference numerals, and description thereof may be omitted. In the specification, “to” indicating a numerical range means that numerical values described before and after “to” are included as a lower limit value and an upper limit value.

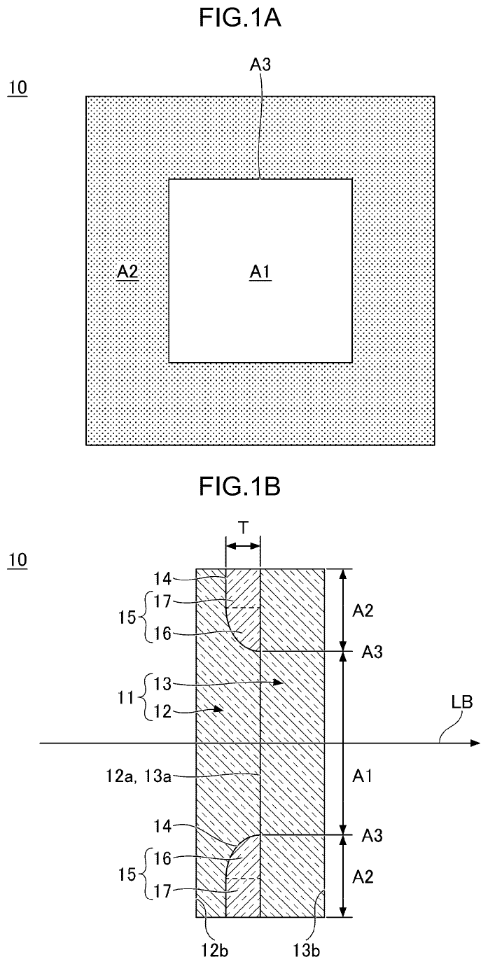

An optical element 10 according to an embodiment will be described with reference to FIGS. 1A and 1B. In FIG. 1B, an arrow direction indicates a transmission direction of light LB. Note that the transmission direction of the light LB may be a direction opposite to the arrow direction. In the present embodiment, the transmission direction of the light LB is a direction perpendicular to a main surface of a glass substrate, but may be an oblique direction with respect to the glass substrate. The light LB is visible light in the present embodiment, but may be ultraviolet light or infrared light. The optical element 10 is used, for example, in an optical system of an imaging device.

As illustrated in FIG. 1A, when viewed from the transmission direction of the light LB, the optical element 10 includes a transmission region A1 that transmits a part of the light LB and a light-shielding region A2 that shields another part of the light LB, and adjusts the shape of the light LB. In FIG. 1A, A3 is a boundary line between the transmission region Al and the light-shielding region A2 when viewed from the transmission direction of the light LB.

As illustrated in FIG. 1B, the optical element 10 includes a transparent glass body 11 and a light-shielding film 15. The light-shielding film 15 forms the light-shielding region A2 inside the transparent glass body 11. The light-shielding region A2 is a region where the light-shielding film 15 is provided. The transparent glass body 11 is provided on both an upstream side and a downstream side in the transmission direction of the light LB with the light-shielding film 15 interposed therebetween.

The light-shielding film 15 is made of glass in the present embodiment. If the light-shielding film 15 is made of glass, the absolute value of a difference Δα between average linear expansion coefficients of the transparent glass body 11 and the light-shielding film 15 can be reduced, and durability of the optical element 10 against a temperature change can be improved. Δα is a value obtained by subtracting the average linear expansion coefficient of the transparent glass body 11 from the average linear expansion coefficient of the light-shielding film 15.

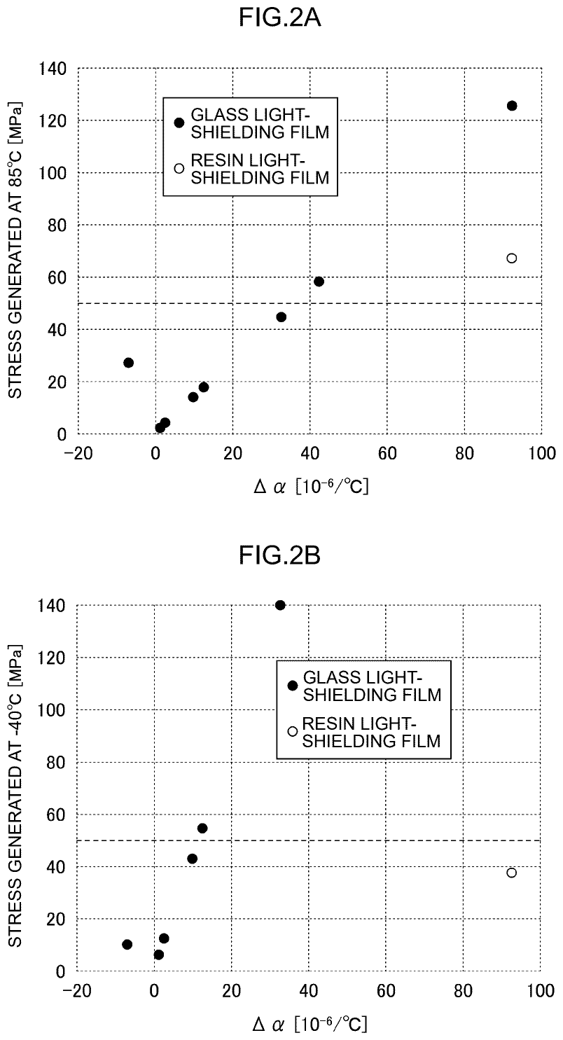

The difference Aa between the average linear expansion coefficients of the transparent glass body 11 and the light-shielding film 15 is measured in accordance with, for example, JIS R3102:1995. The range of the measurement temperature is, for example, −40° C. to 85° C. FIG. 2A illustrates an example of a relationship between stress generated at the boundary line A3 between the transmission region A1 and the light-shielding region A2 when the temperature of the optical element 10 is 85° C. and the difference Aa between the average linear expansion coefficients of the transparent glass body 11 and the light-shielding film 15. FIG. 2B illustrates an example of a relationship between stress generated at the boundary line A3 between the transmission region A1 and the light-shielding region A2 when the temperature of the optical element 10 is −40° C. and the difference Aa between the average linear expansion coefficients of the transparent glass body 11 and the light-shielding film 15.

The analysis conditions in FIGS. 2A and 2B were as follows.
Thermal stress analysis software: Solidworks Simulation manufactured by Dassault Systems SolidWorks Corporation,
Average linear expansion coefficient of transparent glass B1: 7.2×10⁻⁶/° C.,
Young's modulus of transparent glass B1: 70 GPa,
Average linear expansion coefficient of black glass B2: 0.5×10⁻⁶/° C. to 100×10⁻⁶/° C.,
Young's modulus of black glass B2: 70 GPa,
Average linear expansion coefficient of black resin B3: 100×10⁻⁶/° C., and
Young's modulus of black resin B3: 3 GPa.

In FIGS. 2A and 2B, black circles indicate stresses generated when the material of the transparent glass body 11 is the above-described transparent glass B1 and the material of the light-shielding film 15 is the above-described black glass B2, that is, when Δα is −6.7×10⁻⁶/° C. to 92.8×10⁻⁶/° C. In addition, in FIGS. 2A and 2B, white circles indicate stresses generated when the material of the transparent glass body 11 is the above-described transparent glass B1 and the material of the light-shielding film 15 is the above-described black resin B3, that is, when Δα is 92.8×10⁻⁶/° C.

In a case where the material of the transparent glass body 11 is the above-described transparent glass B1 and the material of the light-shielding film 15 is the above-described black resin B3 (see the white circle in FIG. 2A), when the temperature of the optical element 10 was raised from 20° C. to 85° C., the transparent glass body 11 broke. On the other hand, in a case where the material of the transparent glass body 11 is the above-described transparent glass B1 and the material of the light-shielding film 15 is the above-described black glass B2 (however, average linear expansion coefficient: 8.6×10⁻⁶/° C.), the transparent glass body 11 did not break even when the temperature of the optical element 10 was increased from 20° C. to 85° C. In addition, in a case where the material of the transparent glass body 11 is the above-described transparent glass B1 and the material of the light-shielding film 15 is the above-described black resin B3 (see the white circle in FIG. 2B), when a heat cycle test of repeating temperature increase and temperature decrease between −40° C. and 85° C. was performed, the transparent glass body 11 broke. On the other hand, in a case where the material of the transparent glass body 11 is the above-described transparent glass B1 and the material of the light-shielding film 15 is the above-described black glass B2 (however, average linear expansion coefficient: 8.6×10⁻⁶/° C.), the transparent glass body 11 did not break even when the above-described heat cycle test was performed.

In FIGS. 2A and 2B, broken lines indicate that the stress is 50 MPa. From the results of FIGS. 2A and 2B and the above-described heat cycle test, it is considered that when the stress generated at the boundary line A3 between the transmission region A1 and the light-shielding region A2 is 50 MPa or less, breakage of the transparent glass body 11 can be suppressed. Therefore, the absolute value of the difference Δα between the average linear expansion coefficients of the transparent glass body 11 and the light-shielding film 15 is preferably 10×10⁻⁶/° C. or less, more preferably 5×10⁻⁶/° C. or less, and still more preferably 1×10⁻⁶/° C. or less. The absolute value of Δα is preferably as small as possible, as long as it is 0×10⁻⁶/° C. or more.

As illustrated in FIG. 1B, the transparent glass body 11 may include a first transparent glass layer 12 and a second transparent glass layer 13. The first transparent glass layer 12 and the second transparent glass layer 13 are provided with the light-shielding film 15 interposed therebetween in the transmission direction of the light LB, and are continuously in contact with each other in the transmission region A1. In the transmission region A1, there is nothing needed between the first transparent glass layer 12 and the second transparent glass layer 13. The first transparent glass layer 12 and the second transparent glass layer 13 are bonded.

Each of the first transparent glass layer 12 and the second transparent glass layer 13 is a glass substrate. The glass of the glass substrate is not particularly limited, and is, for example, soda-lime glass, alkali-free glass, chemically strengthened glass, borosilicate glass, or lanthanum borate glass. The first transparent glass layer 12 and the second transparent glass layer 13 may be made of different glasses, but are preferably made of the same glass from the viewpoint of durability of the optical element 10 against a temperature change.

The first transparent glass layer 12 and the second transparent glass layer 13 have bonding surfaces 12a and 13a facing each other, respectively. The bonding surfaces 12a and 13a preferably have a flat surface. The flat surfaces of the bonding surfaces 12a and 13a are provided in the transmission region A1. If the bonding surfaces 12a and 13a have a flat surface, the first transparent glass layer 12 and the second transparent glass layer 13 can be uniformly pressed against each other and uniformly bonded in the transmission region A1.

The first transparent glass layer 12 and the second transparent glass layer 13 have opposite surfaces 12b and 13b opposite to the bonding surfaces 12a and 13a, respectively. The opposite surfaces 12b and 13b both have a flat surface in the present embodiment, but at least one of them may have a curved surface. The curved surface may constitute a lens surface, and the optical element 10 may function as a lens. The lens may be any of a plano-convex lens, a biconvex lens, a plano-concave lens, and a biconcave lens.

The first transparent glass layer 12 and the second transparent glass layer 13 may have a recess (also referred to as a cavity) 14 on at least one of the bonding surfaces 12a and 13a. In the present embodiment, the recess 14 is formed on the bonding surface 12a of the first transparent glass layer 12, but may be formed on the bonding surface 13a of the second transparent glass layer 13, or may be formed on both the bonding surfaces 12a and 13a. The light-shielding film 15 is embedded in the recess 14.

In the present embodiment, the transparent glass body 11 is formed by bonding the first transparent glass layer 12 and the second transparent glass layer 13, but these transparent glass layers may not be bonded. As will be described in detail later, it is also possible to manufacture the optical element 10 by forming a groove on a surface of the transparent glass body 11 and embedding the light-shielding film 15 in the groove.

The light-shielding film 15 contains an amorphous inorganic oxide, that is, glass as a main component. The content of glass in the light-shielding film 15 is 50 vol % or more. A part of the light-shielding film 15 may be crystallized. The light-shielding film 15 is made of so-called black glass. The black glass may be a common type. In the present embodiment, the black glass is a sintered body obtained by firing a paste containing a transparent glass powder and a black pigment. The sintered body contains a black pigment dispersed in transparent glass. Note that the black glass may be a block body obtained by molding black molten glass. That is, the black glass itself is transparent in the present embodiment, but the glass itself may be black.

The light-shielding film 15 may be glass containing bismuth-based glass or vanadium-based glass in addition to glass containing SiO₂ as a main component. The bismuth-based glass contains Bi₂O₃. The vanadium-based glass contains V₂O₅. Glass containing SiO₂ as a main component tends to have a lower refractive index than bismuth-based glass and vanadium-based glass. In order to suppress reflection at an interface between the transparent glass body 11 and the light-shielding film 15 described later, a material having a refractive index close to that of the transparent glass body 11 is preferably selected as a material of the light-shielding film 15. The “main component” in the present specification is a component contained in the largest amount among the components, and is preferably 50 wt % or more.

Table 1 indicates the relationship among a refractive index difference Δn (Δn=|n1−n2|) between the transparent glass body 11 and the light-shielding film 15, an extinction coefficient k of the light-shielding film 15, and a reflectance R of the light LB at the interface between the transparent glass body 11 and the light-shielding film 15.

TABLE 1
Reflectance R [%] (n1 = 1.52)

| | | Extinction coefficient k | | | | | | | | |
|---|---|---|---|---|---|---|---|---|---|---|
| | | 0 | 0.0001 | 0.0005 | 0.001 | 0.01 | 0.05 | 0.1 | 0.2 | 0.5 |
| Refractive | 0.20 (n2 = 1.32) | 0.50 | 0.50 | 0.50 | 0.50 | 0.50 | 0.53 | 0.62 | 0.99 | 3.49 |
| index | 0.10 (n2 = 1.42) | 0.12 | 0.12 | 0.12 | 0.12 | 0.12 | 0.14 | 0.23 | 0.58 | 2.92 |
| difference | 0.08 (n2 = 1.44) | 0.07 | 0.07 | 0.07 | 0.07 | 0.07 | 0.10 | 0.19 | 0.53 | 2.85 |
| Δn | 0.05 (n2 = 1.47) | 0.03 | 0.03 | 0.03 | 0.03 | 0.03 | 0.06 | 0.14 | 0.47 | 2.75 |
| | 0.00 (n2 = 1.52) | 0.00 | 0.00 | 0.00 | 0.00 | 0.00 | 0.03 | 0.11 | 0.43 | 2.63 |
| | 0.05 (n2 = 1.57) | 0.03 | 0.03 | 0.03 | 0.03 | 0.03 | 0.05 | 0.13 | 0.44 | 2.58 |
| | 0.08 (n2 = 1.60) | 0.07 | 0.07 | 0.07 | 0.07 | 0.07 | 0.09 | 0.17 | 0.47 | 2.57 |
| | 0.10 (n2 = 1.62) | 0.10 | 0.10 | 0.10 | 0.10 | 0.10 | 0.13 | 0.20 | 0.51 | 2.57 |
| | 0.20 (n2 = 1.72) | 0.38 | 0.38 | 0.38 | 0.38 | 0.38 | 0.40 | 0.48 | 0.76 | 2.70 |
| | 0.30 (n2 = 1.82) | 0.81 | 0.81 | 0.81 | 0.81 | 0.81 | 0.83 | 0.90 | 1.16 | 2.98 |

The reflectance R was calculated by the following formula (1).

$$R = ( {( n 1 - n 2 )}^{2} + {k}^{2} ) / ( {( n 1 + n 2 )}^{2} + {k}^{2} ) \qquad ( 1 )$$

The reflectance R mainly varies depending on the refractive index difference Δn and the extinction coefficient k. Note that n1 is a refractive index of the transparent glass body 11, and n2 is a refractive index of the light-shielding film 15. In Table 1, n1 is 1.52 (constant). n1, n2, and k are measured at the wavelength same as the light LB. The refractive index n1 of the transparent glass body 11 is measured by, for example, a V block method. The refractive index n2 and the extinction coefficient k of the light-shielding film 15 are measured by, for example, an ellipsometer.

The extinction coefficient k of the light-shielding film 15 can also be calculated by the following formula (2) by exposing the light-shielding film 15 by polishing or the like, and measuring the thickness of the light-shielding film 15 and the transmittance of the light-shielding film 15. The thickness of the exposed light-shielding film 15 is measured by, for example, a micrometer. The transmittance of the light-shielding film 15 is measured by, for example, a spectrophotometer.

$$k = αλ / 4 π \qquad ( 2 )$$

In formula (2), α is an absorption coefficient, and λ is a wavelength of light used for measurement of transmittance. The absorption coefficient α is calculated by the following formula (3).

$$I = {I}_{0} exp ( - α t ) \qquad ( 3 )$$

In formula (3), t represents the thickness of the light-shielding film 15, I₀ represents the intensity of light before transmitting through the light-shielding film 15, and I represents the intensity of light after transmitting through the light-shielding film 15.

The reflectance R of the light LB at the interface between the transparent glass body 11 and the light-shielding film 15 may be measured by, for example, a microspectrometer.

The refractive index difference Δn is preferably 0.10 or less and the extinction coefficient k is preferably 0.05 or less. When the refractive index difference Δn is 0.10 or less and the extinction coefficient k is 0.05 or less, the reflectance R becomes 0.15% or less. When the reflectance R is 0.15% or less, stray light can be suppressed. The reflectance R is preferably 0.15% or less, and more preferably 0.10% or less.

The smaller the refractive index difference Δn, the smaller the reflectance R. The refractive index difference Δn is preferably 0.10 or less, more preferably 0.08 or less, and still more preferably 0.05 or less. In addition, the smaller the extinction coefficient k, the smaller the reflectance R. The extinction coefficient k is preferably 0.05 or less, and more preferably 0.01 or less. However, when the extinction coefficient k is too small, the light-shielding property cannot be sufficiently obtained. The extinction coefficient k is preferably 0.0001 or more.

Note that the reflectance R also depends on a surface roughness Ra of the interface between the transparent glass body 11 and the light-shielding film 15. The surface roughness Ra is an arithmetic average roughness described in JIS B0601:2013. The larger the surface roughness Ra, the smaller the reflectance R. When the surface roughness Ra is 100 nm or more, the reflectance R can be reduced to ½ or less as compared with the case where the surface roughness Ra is 0 nm.

In Table 1, the surface roughness Ra is 0 nm. The surface roughness Ra is preferably 100 nm or more, more preferably 120 nm or more from the viewpoint of the reflectance R. The surface roughness Ra is preferably 6400 nm or less.

The refractive index n1 of the transparent glass body 11 is preferably 1.58 or more, and more preferably 1.65 or more. As the refractive index n1 of the transparent glass body 11 is higher, an optical path length (distance x refractive index) is longer, so that the optical element 10 may be downsized. In addition, as described above, the refractive index difference Δn (42 n=|n1−n2|) between the transparent glass body 11 and the light-shielding film 15 is preferably as small as possible. In general, glass can have a higher refractive index than resin. When the light-shielding film 15 is made of glass instead of resin, the refractive index n2 of the light-shielding film 15 can be increased. Note that, the refractive index is a value evaluated at a wavelength of 588 nm (d line).

In a case where the black glass is a sintered body obtained by firing a paste containing a transparent glass powder and a black pigment, the black glass contains, as the black pigment, for example, a metal or a metal compound containing at least one element selected from Fe, Cr, Mn, Co, Ni, Ti, and Cu. The metal compound is, for example, an oxide.

The paste may contain an additive other than the transparent glass powder and the black pigment, and for example, may contain a ceramic powder.

The firing temperature of the paste is set to a temperature equal to or higher than the softening point of glass constituting the paste. The glass constituting the paste is the same as the glass constituting the light-shielding film 15. Therefore, the softening point of the glass constituting the light-shielding film 15 is preferably equal to or lower than the bending point of the glass constituting the transparent glass body 11. Unintended deformation of the transparent glass body 11 at the time of firing the paste can be suppressed. The softening point of glass is measured by, for example, a differential thermal analyzing device.

In a case where the black glass is a block body obtained by molding black molten glass, that is, a case where the glass itself is colored in black, the black glass contains, as a coloring component, at least one element selected from, for example, Fe, Cr, Mn, Co, Ni, Ti, V, and Cu.

In a case where the black glass itself is colored in black, the black glass may contain, in terms of mass % on oxide basis, 50% to 75% of SiO₂, 0% to 20% of Al₂O₃, 0% to 20% of Na₂O, 0% to 20% of K₂O, 0% to 15% of MgO, 0% to 20% of Cao, 10% to 20% of B₂O₃, 0% to 20% of ΣRO (R is Mg, Ca, Sr, Ba, or Zn), 0% to 5% of ZrO₂, 1.0% to 14% of Fe₂O₃, 0% to 2% of CoO or Co₃O₄, and 0% to 0.5% of SO₃, for example. ΣRO is the total content of MgO, CaO, SrO, BaO, and ZnO.

In a case where the black glass itself is colored in black, the black glass may contain at least one selected from V₂O₅, CrO, MnO, CuO, MoO₃, and CeO₂ as long as the coloring is not impaired. The total content of V₂O₅, CrO, MnO, CuO, MoO₃, and CeO₂ is preferably 0% to 3%, and more preferably 0% to 1% in terms of mass % on oxide basis.

In a case where the black glass itself is colored in black, the black glass may contain at least one selected from SO₃, Sb₂O₃, SnO, Cl, and F as a clarifying agent as long as the coloring is not impaired. The total content of SO₃, Sb₂O₃, SnO, Cl, and F is preferably 0% to 1%, and more preferably 0% to 0.5%.

In the light-shielding film 15, the ratio of the maximum value TO of the thickness T in the transmission direction of the light LB to the width in the direction orthogonal to the transmission direction of the light LB (T0/width) is preferably 1 to 1/500, more preferably 1/2 to 1/500, and still more preferably 1/4 to 1/250.

The light-shielding film 15 may have, at the boundary line A3 between the light-shielding region A2 and the transmission region A1, a tapered portion 16 in which the thickness T in the transmission direction of the light LB decreases from the light-shielding region A2 toward the transmission region A1. The thickness T of the tapered portion 16 increases as the distance from the boundary line A3 increases when viewed from the transmission direction of the light LB. The tapered portion 16 is in contact with the boundary line A3. The tapered portion 16 is provided at at least a part of the boundary line A3, and is preferably provided at the entire boundary line A3.

The tapered portion 16 can continuously change the internal transmittance of the light LB at the boundary line A3 and the vicinity thereof. The tapered portion 16 is in contact with the boundary line A3 in the light-shielding region A2, and continuously increases the internal transmittance of the light LB as the distance from the boundary line A3 increases. The internal transmittance is a transmittance excluding a loss due to surface reflection. As compared with a case where the internal transmittance of the light LB discontinuously changes at the boundary line A3, diffraction of the light LB can be suppressed, and generation of stray light can be suppressed. Note that, the change in the internal transmittance of the light LB at the boundary line A3 and the vicinity thereof will be described later. The internal transmittance of the light-shielding film 15 can be obtained from the absorption coefficient α described above, and can be obtained from exp (−αt). Here, t is the thickness of the light-shielding film 15.

The light-shielding film 15 includes a constant thickness portion 17 having a constant thickness T in the transmission direction of the light LB in a region farther from the boundary line A3 than the tapered portion 16. The constant thickness portion 17 is formed continuously with the tapered portion 16. The thickness T of the constant thickness portion 17 is the same as the maximum value TO of the thickness T of the tapered portion 16. Note that the light-shielding film 15 does not need to have the constant thickness portion 17, and may have only the tapered portion 16.

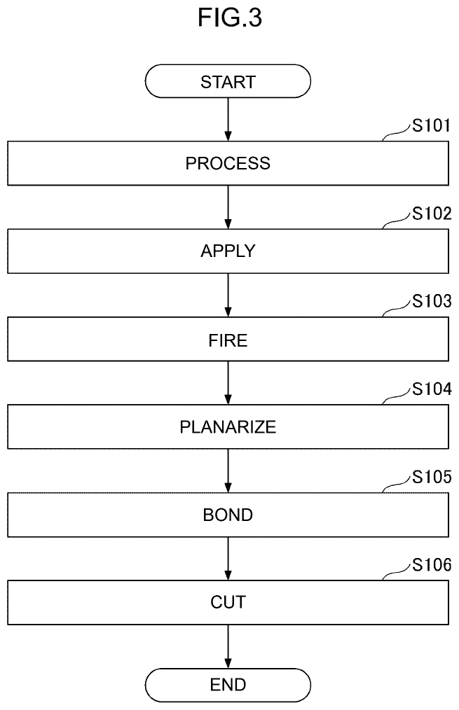

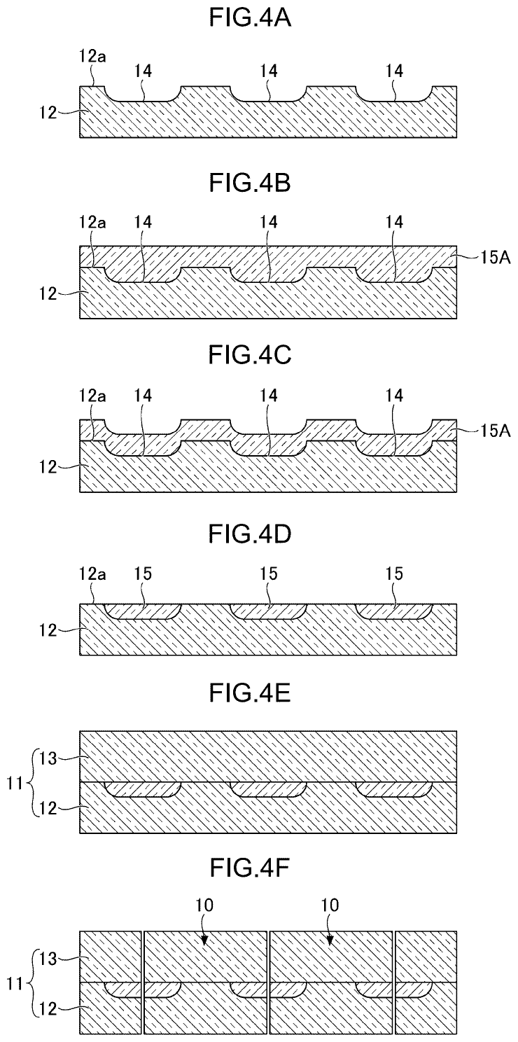

A method for manufacturing the optical element 10 according to the embodiment will be described with reference to FIGS. 3 to 4F. As indicated in FIG. 3, the manufacturing method includes, for example, steps S101 to S106. Note that the manufacturing method does not need to include all of steps S101 to S106. For example, when the optical element 10 is manufactured one at a time, step S106 may be omitted. In addition, the manufacturing method may include steps other than steps S101 to S106.

Step S101 includes processing the first transparent glass layer 12, for example, as illustrated in FIG. 4A. The recess 14 is formed on the bonding surface 12a of the first transparent glass layer 12. The recess 14 is formed in, for example, a square lattice shape. A groove width of the recess 14 is, for example, 1 mm to 5 mm. The maximum value of the depth of the recess 14 is determined based on the maximum value TO of the thickness T of the light-shielding film 15 and the amount of change in the depth of the recess 14 in the subsequent steps. In a case where the depth of the recess 14 changes in step S104 and step S105 described later, the depth of the recess 14 is determined so that the maximum value of the thickness T of the light-shielding film 15 after the end of step S105 becomes T0. Note that T0 is set according to the extinction coefficient of the light-shielding film 15. In a case where the extinction coefficient of the light-shielding film 15 is about 0.01, the maximum value TO of the thickness T of the light-shielding film 15 is, for example, 20 μm to 50 μm, in a case where the extinction coefficient of the light-shielding film 15 is about 0.001, the maximum value T0 of the thickness T of the light-shielding film 15 is, for example, 200 μm to 500 μm, and in a case where the extinction coefficient of the light-shielding film 15 is about 0.0003, the maximum value T0 of the thickness T of the light-shielding film 15 is, for example, 800 μm to 1300 μm. In the present embodiment, the recess 14 is formed on the bonding surface 12a of the first transparent glass layer 12, but may be formed on the bonding surface 13a of the second transparent glass layer 13, or may be formed on both the bonding surfaces 12a and 13a. The processing of glass includes, for example, wet etching or machining.

Step S102 includes applying a paste 15A, for example, as illustrated in FIG. 4B. For example, the paste 15A is applied thicker than the depth of the recess 14, to the entire bonding surface 12a on which the recess 14 is formed. An application machine of the paste 15A includes, for example, a screen printing machine or a dispenser. Note that the paste 15A only needs to be filled in at least the recess 14, and may be applied only to the recess 14.

Step S103 includes firing the paste 15A, for example, as illustrated in FIG. 4C. The glass powder and the black pigment constituting the paste 15A are sintered to obtain the light-shielding film 15. The firing temperature of the paste 15A is set to a temperature equal to or higher than the softening point of the glass constituting the paste 15A. The glass constituting the paste 15A is the same as the glass constituting the light-shielding film 15. Thus, the softening point of the glass constituting the light-shielding film 15 is preferably equal to or lower than the bending point of the glass of the first transparent glass layer 12. Unintended deformation of the first transparent glass layer 12 at the time of firing the paste 15A can be suppressed.

Step S104 includes planarizing the light-shielding film 15, for example, as illustrated in FIG. 4D. The planarization of the light-shielding film 15 includes at least one of lapping and polishing. The planarization of the light-shielding film 15 may further include wet etching. The planarization of the light-shielding film 15 is performed until the first transparent glass layer 12 is exposed. The light-shielding film 15 is formed in, for example, a square lattice shape by the planarization.

Step S105 includes bonding the first transparent glass layer 12 and the second transparent glass layer 13, for example, as illustrated in FIG. 4E. The first transparent glass layer 12 and the second transparent glass layer 13 are bonded by a hydrogen bond between OH groups imparted to the glass surfaces, by a covalent bond generated by dehydration condensation after generation of a hydrogen bond, or by a van der Waals force between the glass surfaces.

For example, step S105 includes, in the following order, modifying the surface of the glass substrate by plasma treatment, applying an OH group to the modified surface, superimposing the glass substrates with the surfaces to which the OH group is applied facing each other, and heat-treating the superimposed glass substrates. The OH group is applied by supplying pure water or water vapor.

Alternatively, step S105 includes, in the following order, treating the surface of the glass substrate with an alkaline detergent, washing the surface treated with the alkaline detergent with pure water, superimposing the glass substrates with the surfaces washed with pure water facing each other, and heat-treating the superimposed glass substrates. Here, it is possible to omit treatment of the surface of the glass substrate with an alkaline detergent.

Note that step S105 may include welding the glass substrates to each other. The welding temperature is set to a temperature equal to or higher than a glass transition point of the glass substrate. At the time of welding, the glass substrates may be pressed and pressure-bonded.

For example, as illustrated in FIG. 4F, step S106 includes cutting the bonded body obtained in step S105 into a plurality of optical elements 10. The cutting includes, for example, blade processing or laser processing.

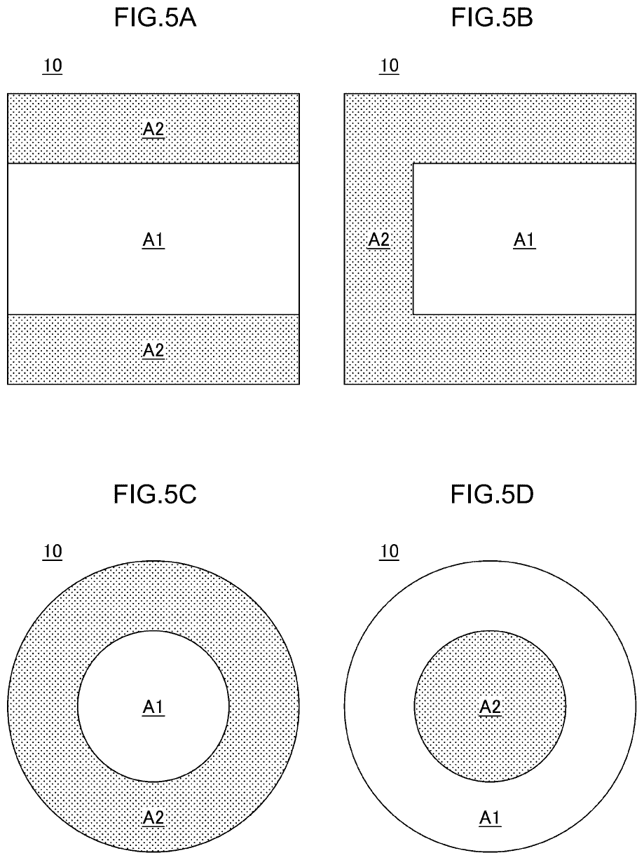

First to fourth modifications of the shape of the light-shielding region A2 when viewed from the transmission direction of the light LB will be described with reference to FIGS. 5A to 5D. The shape of the light-shielding region A2 when viewed from the transmission direction of the light LB is a quadrangular frame shape as illustrated in FIG. 1A in the embodiment described above, but is not limited to the quadrangular frame shape. The shape of the light-shielding region A2 may be a shape in which two rectangles illustrated in FIG. 5A are arranged in parallel at an interval, a U-shape illustrated in FIG. 5B, an annular shape illustrated in FIG. 5C, a circular shape illustrated in FIG. 5D, or the like. The light-shielding region A2 may be disposed outside the transmission region A1 as illustrated in FIGS. 1A, 5A, 5B, and 5C, or may be disposed inside the transmission region A1 as illustrated in FIG. 5D.

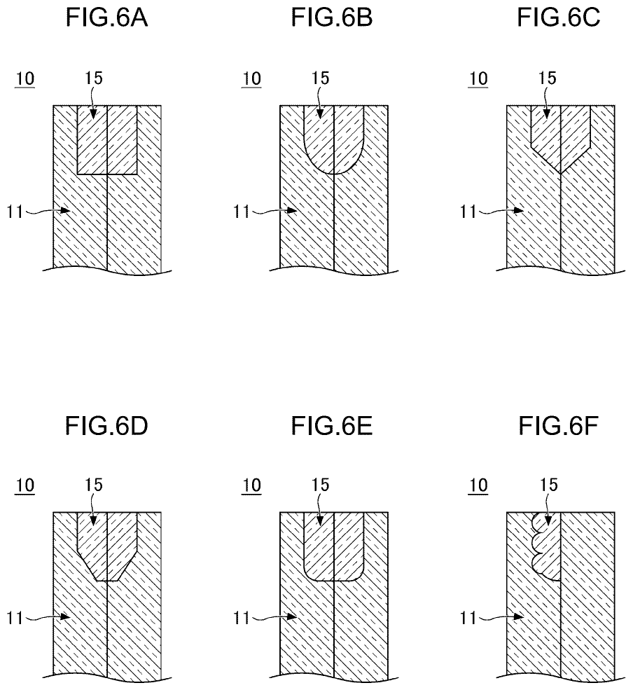

First to sixth modifications of the cross-sectional shape of the light-shielding film 15 cut perpendicularly to the boundary line A3 when viewed from the transmission direction of the light LB will be described with reference to FIGS. 6A to 6F. In the embodiment described above, the cross-sectional shape of the light-shielding film 15 is a shape obtained by combining a rectangle and a quadrant as illustrated in FIG. 1B, but is not limited to this shape. The cross-sectional shape of the light-shielding film 15 may be a rectangular shape illustrated in FIG. 6A, a shape obtained by combining a rectangle and a semicircle illustrated in FIG. 6B, a shape obtained by combining a rectangle and an isosceles triangle illustrated in FIG. 6C, a shape obtained by combining a rectangle and an isosceles trapezoid illustrated in FIG. 6D, a shape obtained by rounding two corners of a rectangle illustrated in FIG. 6E, a waveform shape illustrated in FIG. 6F, or the like.

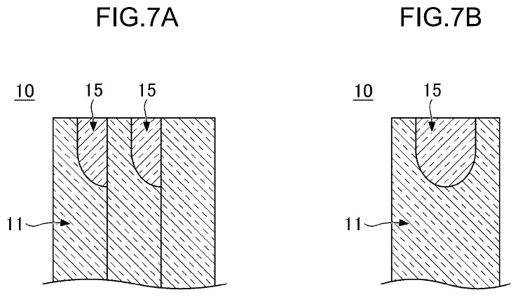

As illustrated in FIG. 7A, a plurality of light-shielding films 15 may be provided at intervals in the transmission direction of the light LB. In addition, as illustrated in FIG. 7B, it is also possible to manufacture the optical element 10 by forming a groove on a surface of the transparent glass body 11 and embedding the light-shielding film 15 in the groove.

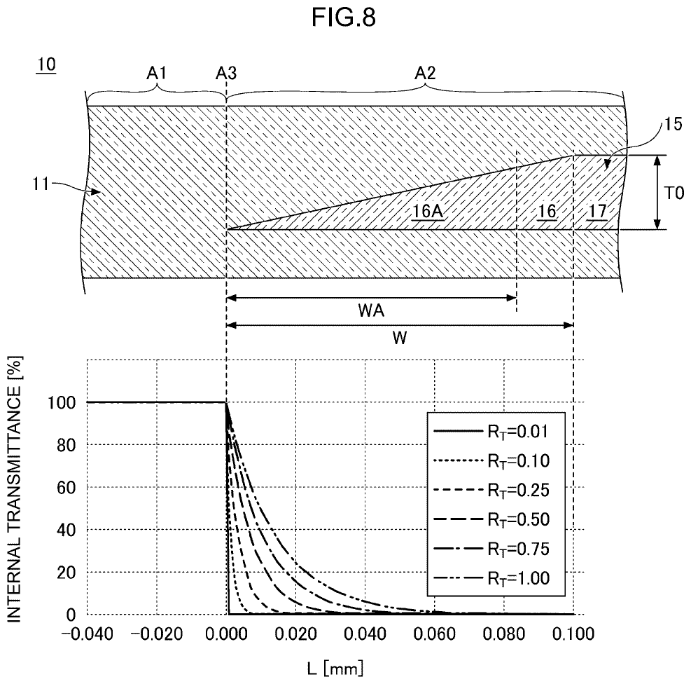

An example of the relationship between the cross-sectional shape of the light-shielding film 15 cut perpendicular to the boundary line A3 when viewed from the transmission direction of the light LB and the internal transmittance of the light LB in the light-shielding film 15 will be described with reference to FIG. 8. In FIG. 8, for convenience of the drawing, the cross-sectional shape of the light-shielding film 15 is illustrated by being compressed in the transmission direction of the light LB (downward direction in FIG. 8). In FIG. 8, the maximum value TO of the thickness T of the tapered portion 16 is 0.100 mm, and the width W of the tapered portion 16 is 0.100 mm.

In FIG. 8, L represents a distance from the boundary line A3. L being positive indicates a position shifted from the boundary line A3 to the light-shielding region A2. In addition, L being negative indicates a position shifted from the boundary line A3 to the transmission region A1.

Furthermore, in FIG. 8, R_{T} represents a ratio of the thickness T1 corresponding to the internal transmittance of 0.1% of the light LB to the maximum value T0 of the thickness T of the tapered portion 16 (T1/T0). R_{T} represents the black density of the light-shielding film 15. R_{T} can be adjusted by the content of the black pigment in the light-shielding film 15. The smaller the content of the black pigment, the lower the black density of the light-shielding film 15 and the larger the R_{T}.

In the tapered portion 16, the internal transmittance of the light LB at the position where the thickness T becomes the maximum value T0 is preferably 0.1% or less. When the internal transmittance of the light LB at the position where the thickness T becomes the maximum value T0 is 0.1% or less, the transmission of the light LB at the position where the thickness T becomes the maximum value T0 can be sufficiently suppressed, and the shape of the light LB can be sufficiently adjusted.

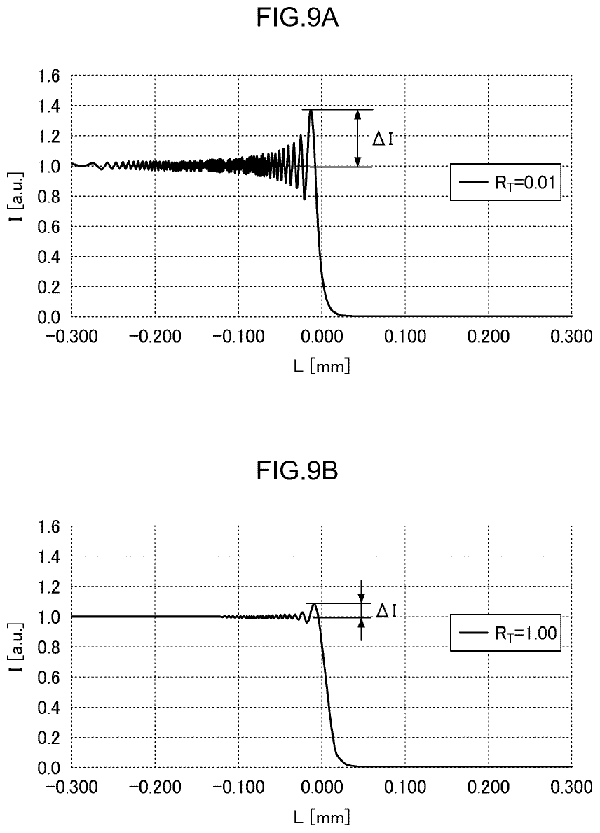

In addition, R_{T} (R_{T}=T1/T0) is preferably as large as possible. As illustrated in FIG. 8, as R_{T} is larger, the change in the internal transmittance of the light LB can be made gentler at the boundary line A3 and the vicinity thereof. As a result, ΔI decreases as R_{T} increases as illustrated in FIGS. 9A and 9B. Note that, when the internal transmittance of the light LB at the position where the thickness T becomes the maximum value T0 is 0.1% or less, R_{T} is 1.00 or less as is clear from the formula “R_{T}=T1/T0”.

In FIGS. 9A and 9B, I is the intensity (relative value) of the light LB on the projection surface, and ΔI is the fluctuation range of the intensity of the light at the position where the boundary line A3 is projected on the projection surface. In FIGS. 9A to 12, the distance from the light-shielding film 15 to the projection surface is 0.5 mm. The intensity I of light transmitted through a position sufficiently far from the boundary line A3 in the transmission region A1 is set as a reference value (1.0). Note that the average value of the intensity I of light in the transmission region A1 may be used as the reference value (1.0). ΔI is expressed as a percentage (%) with respect to the reference value. The smaller ΔI, the weaker the diffraction of the light LB.

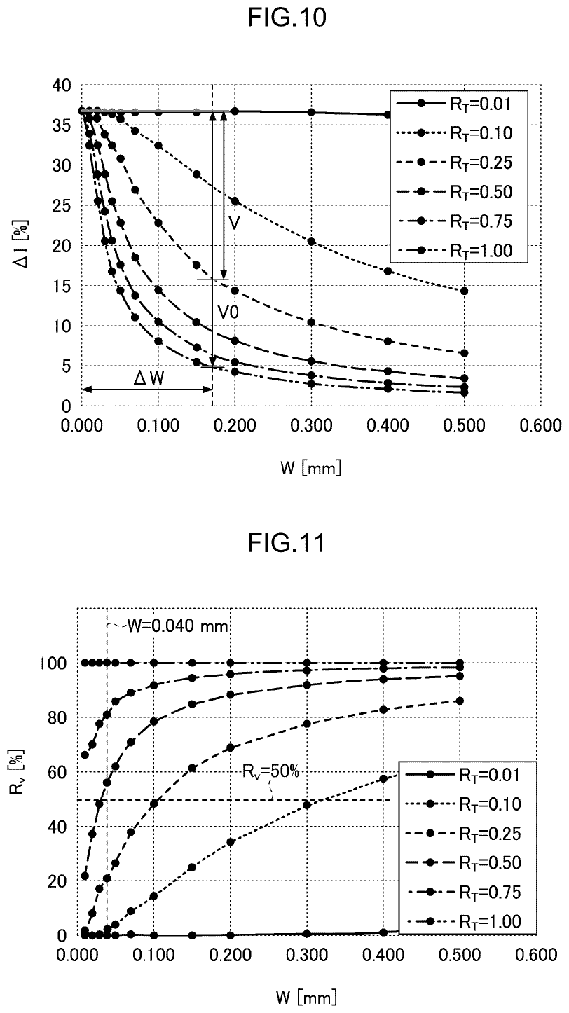

FIG. 10 illustrates an example of the relationship among ΔI, W, and R_{T}. As illustrated in FIG. 10, ΔI depends on R_{T} and W. When W is larger than 0.000 and constant, ΔI decreases as R_{T} increases. However, when W is 0.000, ΔI does not depend on R_{T}. In addition, when R_{T} is constant, ΔI decreases as W increases.

As illustrated in FIG. 10, the effect of reducing ΔI is expressed by a ratio R_{V} (%) of the weight reduction V of ΔI when W changes by ΔW from 0.000 mm when R_{T} is 1.00 to the weight reduction V0 of ΔI when W changes by ΔW from 0.000 mm when R_{T} is constant. R_{V} is calculated according to the following formula (4):

$${R}_{v} = V / V 0 \times 100 \qquad ( 4 )$$

ΔW is an arbitrary value.

FIG. 11 illustrates an example of the relationship among R_{V}, W, and R_{T}. As can be seen from FIG. 11, when R_{T} is 0.50 or more, R_{V} is 50% or more in a range where W is 0.040 mm or more. Therefore, R_{T} is preferably 0.50 or more, and more preferably 0.75 or more. Note that, although R_{T} is preferably as large as possible, R_{T} is 1.00 or less as is clear from the formula “R_{T}=T1/T0”.

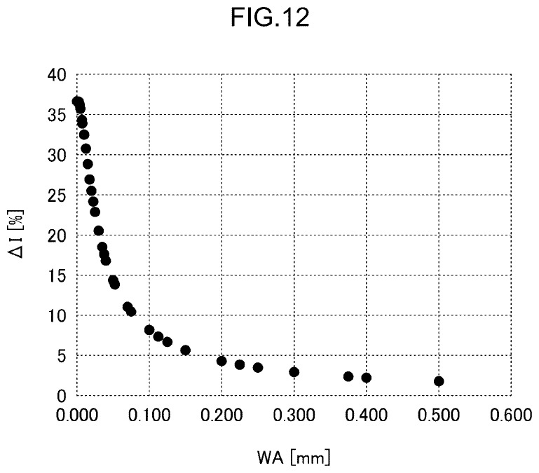

FIG. 12 illustrates an example of the relationship between ΔI and WA. WA is a width of a portion 16A where the internal transmittance of the light LB is 0.1% or more when the tapered portion 16 is viewed from the transmission direction of the light LB as illustrated in FIG. 8. WA is W or less.

As can be seen from FIG. 12, when WA is 0.040 mm (40 μm) or more, ΔI can be reduced to half or less as compared with the case where WA is 0.000 mm (0 μm).

Therefore, WA is preferably 40 μm or more, more preferably 100 μm or more, and still more preferably 200 μm or more. Note that WA is preferably as large as possible, but may be 500 μm or less from the viewpoint of adjusting the shape of the light LB.

W is greater than or equal to WA. Therefore, W is preferably 40 μm or more, more preferably 100 μm or more, and still more preferably 200 μm or more. Note that W is preferably as large as possible, but may be 500 μm or less from the viewpoint of adjusting the shape of the light LB.

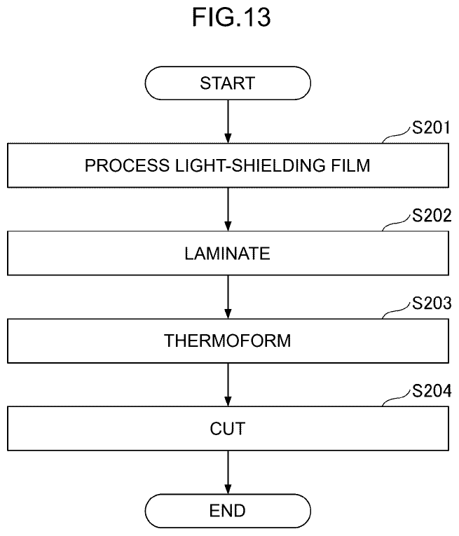

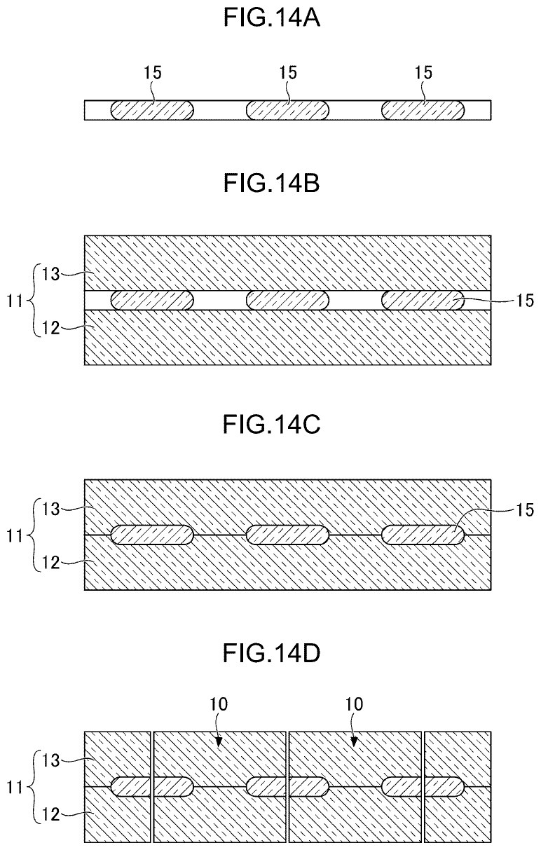

A modification of the method for manufacturing the optical element 10 will be described with reference to FIGS. 13 to 14D. As illustrated in FIG. 13, the manufacturing method includes, for example, steps S201 to S204. Note that the manufacturing method does not need to include all of steps S201 to S204. For example, when the optical element 10 is manufactured one at a time, step S204 may be omitted. In addition, the manufacturing method may include steps other than steps S201 to S204.

Step S201 includes processing the light-shielding film 15, for example, as illustrated in FIG. 14A. The light-shielding film 15 is processed into, for example, a square lattice shape. The processing of the light-shielding film 15 includes, for example, wet etching or machining.

Step S202 includes laminating the first transparent glass layer 12, the light-shielding film 15, and the second transparent glass layer 13 in this order, for example, as illustrated in FIG. 14B. The first transparent glass layer 12 and the second transparent glass layer 13 are disposed with the light-shielding film 15 interposed therebetween.

Step S203 includes thermoforming the laminate obtained in step S202, for example, as illustrated in FIG. 14C. The first transparent glass layer 12 and the second transparent glass layer 13 are thermally deformed and come into contact with each other. At this time, the light-shielding film 15 does not need to be thermally deformed. The glass transition point of the glass constituting the light-shielding film 15 is preferably higher than the glass transition points of the first transparent glass layer 12 and the second transparent glass layer 13.

For example, as illustrated in FIG. 14D, step S204 includes cutting the bonded body obtained in step S203 into a plurality of optical elements 10. The cutting includes, for example, blade processing or laser processing.

Although the optical element and the method for manufacturing the optical element according to the present disclosure have been described above, the present disclosure is not limited to the above-described embodiment and the like. Various changes, modifications, substitutions, additions, deletions, and combinations are possible within the scope described in the claims. They also naturally belong to the technical scope of the present disclosure.

The present application claims priority based on Japanese Patent Application No. 2023-021436 filed with the Japanese Patent Office on Feb. 15, 2023 and Japanese Patent Application No. 2023-087578 filed with the Japanese Patent Office on May 29, 2023, and the entire contents of Japanese Patent Application No. 2023-021436 and Japanese Patent Application No. 2023-087578 are incorporated herein by reference.

According to one aspect of the present disclosure, since a light-shielding film made of glass is used, the absolute value of a difference between average linear expansion coefficients of a transparent glass body and the light-shielding film can be reduced, and durability of an optical element against a temperature change can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical element that includes a transmission region that transmits a part of light and a light-shielding region that shields another part of the light when viewed from a transmission direction of the light, the optical element comprising:
a transparent glass body; and
a light-shielding film made of glass that forms the light-shielding region inside the transparent glass body.

2. The optical element according to claim 1, wherein a reflectance of the light at an interface between the transparent glass body and the light-shielding film is 0.15% or less.

3. The optical element according to claim 1, wherein the light-shielding film includes a tapered portion in which a thickness in a transmission direction of the light increases as a distance from a boundary line between the light-shielding region and the transmission region increases when the light-shielding film is viewed from the transmission direction of the light, and
the tapered portion is in contact with the boundary line.

4. The optical element according to claim 3, wherein in the light-shielding film, an internal transmittance of the light at a position where the thickness of the tapered portion becomes a maximum value T0 is 0.1% or less, and a ratio R_{T} of the thickness T1 corresponding to the internal transmittance of 0.1% of the light to the maximum value T0 of the thickness (R_{T}=T1/T0) is 0.5 or more.

5. The optical element according to claim 3, wherein a width of the tapered portion is 40 μm or more when viewed from the transmission direction of the light.

6. The optical element according to claim 1, wherein an absolute value of a difference between average linear expansion coefficients of the transparent glass body and the light-shielding film is 10×10⁻⁶/° C. or less.

7. The optical element according to claim 1, wherein a softening point of glass constituting the light-shielding film is equal to or lower than a bending point of glass constituting the transparent glass body.

8. The optical element according to claim 1, wherein the transparent glass body includes a first transparent glass layer and a second transparent glass layer, and
the first transparent glass layer and the second transparent glass layer are provided with the light-shielding film interposed therebetween in the transmission direction of the light, and are continuously in contact with each other in the transmission region.

9. The optical element according to claim 1, wherein a refractive index of the transparent glass body is 1.58 or more.

10. The optical element according to claim 1, wherein a refractive index difference between the transparent glass body and the light-shielding film is 0.05 or less.

11. The optical element according to claim 8, wherein the first transparent glass layer and the second transparent glass layer are bonded, and at least one of the first transparent glass layer and the second transparent glass layer includes a cavity in which the light-shielding film is embedded on a bonding surface of the first transparent glass layer or the second transparent glass layer.

12. A method for manufacturing the optical element according to claim 11, comprising:
embedding the light-shielding film in the cavity; and
bonding the first transparent glass layer and the second transparent glass layer by making a bonding surface of the first transparent glass layer and a bonding surface of the second transparent glass layer face each other.
